(19) United States
(12) Patent Application Publication
(10) Pub. No.: US 2008/0169030 A1
(43) Pub. Date: Jul. 17, 2008

(54) Valve Assembly for Transmission Fluid Level Management

(75) Inventors: Norman Schoenek, Novi, MI (US); Mark A. Makowski, Brighton, MI (US); Derril A. Loe, Williamston, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/622,593

(22) Filed: Jan. 12, 2007

(51) Int. Cl. F16K 31/18; F01M 11/12

(52) U.S. Cl. 137/434; 184/103.2

(57) ABSTRACT

A valve assembly for selectively and variably communicating fluid between an auxiliary sump volume and a main sump volume, each defined by a transmission, is provided. The valve assembly includes a float member operatively connected to a valve member and disposed within the main sump volume of the transmission. The valve member is movable between an open position and a closed position. The float member is configured to be buoyed by the fluid within the main sump volume to move the valve member from the open position toward the closed position thereby variably restricting the flow of the fluid between the auxiliary sump volume and the main sump volume as the amount of the fluid within the main sump volume increases. A transmission incorporating the valve assembly is also disclosed.

### TECHNICAL FIELD

The present invention relates to a valve assembly operable to regulate the level of fluid within a main sump volume defined by an automatically shiftable transmission.

### BACKGROUND OF THE INVENTION

The flow of oil or fluid within automatically shiftable transmissions is controlled in a manner to lubricate moving components contained therein and to apply clutches when needed. Transmissions often include a side cover defining an auxiliary sump volume which is configured to store fluid that may be selectively delivered to a main sump volume, defined by the transmission, to provide desired levels of fluid within the transmission. The main sump volume must contain enough fluid to maintain an inlet to a hydraulic pump submerged and account for fluid in transit between operational components of the transmission and the main sump volume. That is, for example, fluid directed to the lubrication circuit becomes fluid in transit once the transmission is put in operation thereby reducing the level or amount of fluid contained within the main sump volume. Thus, the initial sump fill must be at a sufficient level to account for the in transit fluid while maintaining the inlet of the hydraulic pump covered or submerged at all times.

In transit fluid volume is very large at cold temperatures due to the viscosity of the fluid. As temperature increases, fluid volume in transit decreases as viscosity decreases, thereby increasing fluid level within the main sump volume. Typically, this increase in volume is accommodated by the auxiliary sump volume or by making the main sump volume sufficiently deep thereby making room for fluid expansion. If the level of fluid within the main sump volume is excessively high, then the fluid may interfere with the rotating components of the transmission causing spin losses which translate into reduced operating efficiencies of the transmission.

The flow of fluid from the auxiliary sump volume into the main sump volume is typically controlled by a thermostatically controlled valve which is operative to reduce the flow of fluid when the temperature of the fluid is above a predetermined value. The thermostatically controlled valve contains a temperature sensitive strip of metal or thermostatic element that reacts to fluid temperature changes to bias a plate thereby opening or closing a fluid passage. At low fluid temperatures, the thermostatic element exerts little pressure on the plate, which allows fluid to drain into the main sump volume from the auxiliary sump volume. As the temperature of the fluid rises, the thermostatic element begins to apply pressure to the plate, thereby trapping fluid within the auxiliary sump volume. This control is needed to maintain the consistent and reliable operation of the transmission. The thermostatically controlled valve provides a passive control, based on the temperature of the fluid, which may not be adjusted based upon operating conditions of the transmission.

### SUMMARY OF THE INVENTION

A valve assembly for selectively and variably communicating fluid between an auxiliary sump volume and a main sump volume, each defined by a transmission, is provided. The valve assembly includes a float member operatively connected to a valve member and disposed within the main sump volume of the transmission. The valve member is movable between an open position and a closed position. The float member is configured to be buoyed by the fluid within the main sump volume to move the valve member from the open position toward the closed position thereby variably restricting the flow of the fluid between the auxiliary sump volume and the main sump volume as the amount of the fluid within the main sump volume increases.

In one embodiment, the auxiliary sump volume is at least partially defined by a side cover of the transmission. Additionally, a valve body, operable to introduce fluid into the auxiliary sump volume, may be at least partially disposed within the auxiliary sump volume. A transmission incorporating the valve assembly is also disclosed.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic sectional view of an automatically shiftable transmission illustrating a valve assembly, consistent with the present invention, in a fully open position; and

FIG. 2 is a schematic sectional view of the automatically shiftable transmission of FIG. 1 illustrating the valve assembly in a fully closed position.

### DESCRIPTION OF THE PREFERRED EMBODIMENTS

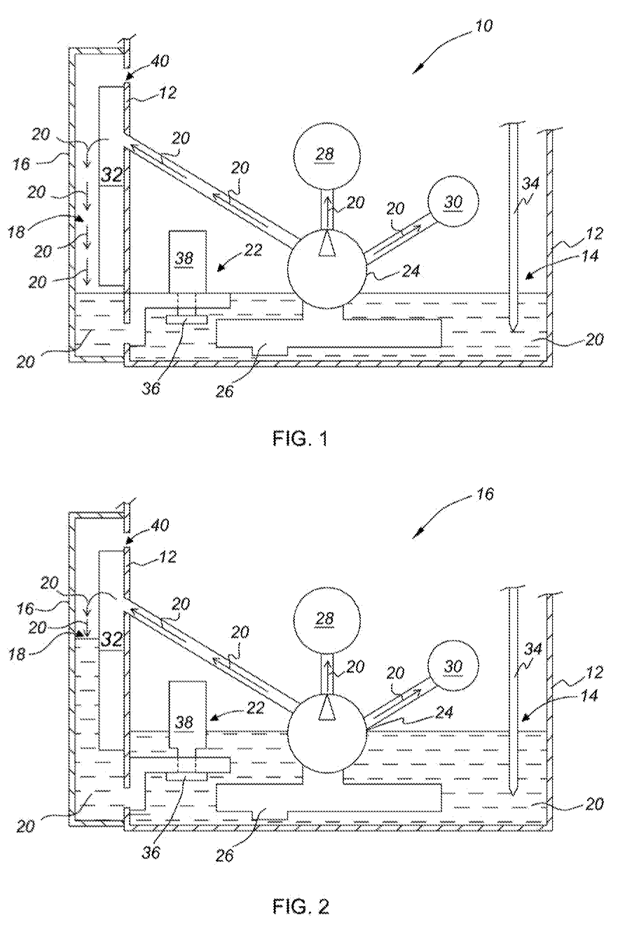

Referring to the drawings wherein like reference numbers correspond to like or similar components throughout the several figures, there is schematically depicted in FIG. 1 a portion of an automatically shiftable transmission 10. The transmission 10 includes a transmission case 12, which at least partially defines a main sump volume 14. A side cover 16 is removably mounted to the transmission case 12. The side cover 16 and the transmission case 12 cooperate to define an auxiliary sump volume 18. The main sump volume 14 and the auxiliary sump volume 18 are configured to contain oil or fluid 20 and are in selective fluid communication with each other through a valve assembly 22.

A positive displacement hydraulic pump 24, having an inlet 26 mounted thereto, is operable to draw fluid 20 from the main sump volume 14 and communicate the fluid 20, under pressure, throughout the transmission 10. The hydraulic pump 24 is operable to provide fluid 20 to components, such as a heat exchanger (not shown), such that this volume of fluid 20 is considered fluid in transit 28. Additionally, the hydraulic pump is operable to provide fluid 20 to a fixed volume 30, such as the volume of fluid 20 required to maintain engagement of various clutches, not shown, within the transmission 10. Furthermore, the hydraulic pump is operable to communicate fluid 20, under pressure, to a valve body 32. Those skilled in the art will recognize that the valve body 32 is operable to selectively direct fluid 20 to various components within the transmission 10, such as to control the selective engagement and disengagement of clutches, not shown. During operation of the transmission 10, the valve body 32 exhausts an amount of fluid 20 into the auxiliary sump volume 18, as indicated by arrows. A fluid level indicator 34 is provided as a means to determine if the amount of fluid 20 contained within the transmission 10 is at an acceptable level. Advantageously, the transmission 10 does not require the auxiliary sump volume 18 to be filled with fluid 20 prior to setting the appropriate level of fluid 20 during the filling of the transmission 10.

The valve assembly 22 includes a valve member 36 and a float member 38 operatively connected thereto. The float member 38 may be mechanically (such as through a mechanical linkage) or electrically (such as through a solenoid controlled valve actuator) connected to the valve member 36. The valve member 36 is shown in FIG. 1 as a tulip type valve; however, those skilled in the art of valve design will appreciate that other types of valves may be used while remaining within the scope of that which is claimed. The valve member 36 is movable between a fully open position, as shown in FIG. 1, and a fully closed position, as shown in FIG. 2. The float member 38 is preferably formed from a material, such as metal or plastic, having the requisite resistance to chemical degradation and heat imposed by the fluid 20. Those skilled in the art will recognize other materials, such as composites, corks, etc., may be used in forming the float member 38 while remaining within the scope of that which is claimed. The float member 38 is configured to be buoyed by the fluid 20 such that as the float member 38 is buoyed, it will move the valve member 36 from the open position toward the closed position. In doing so, the flow of fluid 20 between the auxiliary sump volume 18 and the main sump volume 14 is variably restricted.

In operation of the transmission 10, with cool fluid 20, the volume of fluid in transit 28 is large. Therefore, a low level of fluid 20 remains in the main sump volume 20 as shown in FIG. 1. To avoid starvation of the hydraulic pump 24, and the damage to the transmission 10 that may result, the inlet 26 must remain submerged by the fluid 20. As such, it is desirable to reduce the amount of fluid 20 contained within the auxiliary sump volume 18. Therefore, the fluid 20 entering the auxiliary sump volume 18 from the valve body 32 is allowed to pass to the main sump volume 14 through valve assembly 22. In this state of operation, the amount of fluid 20 entering the auxiliary sump volume 18 is less than that allowed to pass to the main sump volume 14; therefore, no accumulation of fluid 20 within the auxiliary sump volume 18 will occur.

Referring now to FIG. 2, there is shown the transmission 10 of FIG. 1 during operation with warm fluid 20. As is known to those skilled in the art of transmission design, the fluid 20 will expand with increasing temperature. Additionally, the volume of the fluid in transit 28 will be reduced as the viscosity of the fluid 20 decreases. Therefore, the volume of fluid 20 within the main sump volume 14 will increase to a level such that the float member 38 of the valve assembly 22 will be buoyed by the fluid 20. As such, the float member 38 will tend to move the valve member 36 from the open position, shown in FIG. 1, toward the closed position of FIG. 2. In doing so, the valve member 36 will increasingly and variably restrict the flow of fluid 20 between the auxiliary sump volume 18 and the main sump volume 14 until the valve member 36 is in the fully closed position, thereby blocking or preventing communication of fluid 20 between the auxiliary sump volume 18 and the main sump volume 14. By allowing the accumulation of fluid 20 within the auxiliary sump volume 18, the volume of fluid 20 within the main sump volume 14 can be maintained at a preferred level. Therefore, spin losses and resultant decreases in efficiency are reduced by maintaining the level of fluid 20 in the main sump volume 14 within preferred levels during operation of the transmission 10.

An overflow port 40 is defined by the transmission case 12 and is operable to communicate fluid 20 from the auxiliary sump volume 18 to the main sump volume 14 if the level of fluid 20 within the auxiliary sump volume 18 reaches a predetermined height. Fluid 20 discharging from the overflow port 40 may have the undesirable effect of increasing spin-losses within the transmission 10 as the fluid 20 interacts with rotating components of the transmission. Therefore, the buoyancy force of the float member 38 is preferably chosen such that it is less than the maximum force developed by the pressure head of the fluid 20 acting on the valve member 36, thereby allowing the valve member 36 to open as the level of fluid 20 within the auxiliary sump volume 18 approaches the outlet port 40.

While the best modes for carrying out the invention have been described in detail, those familiar with the art to which this invention relates will recognize various alternative designs and embodiments for practicing the invention within the scope of the appended claims.

1. A valve assembly for selectively and variably communicating fluid between an auxiliary sump volume and a main sump volume, each defined by a transmission, the valve assembly comprising:
a float member operatively connected to a valve member and disposed within the main sump volume of the transmission;
wherein said valve member is movable between an open position and a closed position; and
wherein said float member is configured to be buoyed by the fluid within the main sump volume to move said valve member from said open position toward said closed position thereby variably restricting the flow of the fluid between the auxiliary sump volume and the main sump volume as the amount of the fluid within the main sump volume increases.

2. The valve assembly of claim 1, wherein the auxiliary sump volume is at least partially defined by a side cover of the transmission.

3. The valve assembly of claim 1, wherein the transmission includes a valve body and wherein said valve body is at least partially disposed within the auxiliary sump volume.

4. The valve assembly of claim 3, wherein said valve body is operable to introduce the fluid into the auxiliary sump volume.

5. The valve assembly of claim 1, wherein said valve member is a tulip valve.

6. The valve assembly of claim 1, wherein said float member is formed from one of metal and plastic.

7. A transmission comprising:
a main sump volume configured to contain a fluid and defined by the transmission;
an auxiliary sump volume configured to contain said fluid and defined by the transmission;
wherein said main sump volume and said auxiliary sump volume are in selective communication;
a valve assembly operable to selectively and variably restrict flow of said fluid between said auxiliary sump volume and said main sump volume, said valve assembly including:
a float member operatively connected to a valve member and disposed within said main sump volume;
wherein said valve member is movable between an open position and a closed position; and
wherein said float member is configured to be buoyed by said fluid within said main sump volume to move said valve member from said open position toward said closed position thereby variably restricting the flow of said fluid between said auxiliary sump volume and said main sump volume as the amount of said fluid within said main sump volume increases.

8. The transmission of claim 7, further comprising a valve body disposed at least partially within said auxiliary sump volume and operable to communicate said fluid to said auxiliary sump volume.

9. The transmission of claim 7, further comprising:
a side cover; and
wherein said side cover at least partially defines said auxiliary sump volume.

10. The transmission of claim 8, further comprising a hydraulic pump operable to draw said fluid from said main sump volume and communicate said fluid to said valve body.

11. The transmission of claim 7, wherein said valve member is a tulip valve.

12. The transmission of claim 7, wherein said float member is formed from one of metal and plastic.

13. An automatically shiftable transmission comprising:
a transmission case;
a main sump volume configured to contain a fluid and at least partially defined by said transmission case;
an auxiliary sump volume configured to contain said fluid and at least partially defined by said transmission case;
wherein said main sump volume and said auxiliary sump volume are in selective communication;
a valve body at least partially disposed within said auxiliary sump volume and operable to communicate said fluid to said auxiliary sump volume;
a valve assembly operable to selectively and variably restrict flow of said fluid between said auxiliary sump volume and said main sump volume, said valve assembly including:
a float member operatively connected to a valve member and disposed within said main sump volume;
wherein said valve member is movable between an open position and a closed position; and
wherein said float member is configured to be buoyed by said fluid within said main sump volume to move said valve member from said open position toward said closed position thereby variably restricting the flow of said fluid between said auxiliary sump volume and said main sump volume as the amount of said fluid within said main sump volume increases.

14. The automatically shiftable transmission of claim 13, further comprising:
a side cover; and
wherein said side cover at least partially defines said auxiliary sump volume.

15. The automatically shiftable transmission of claim 13, further comprising a hydraulic pump operable to draw said fluid from said main sump volume and communicate said fluid to said valve body.

16. The automatically shiftable transmission of claim 13, wherein said float member is formed from one of metal and plastic.
